(19) United States
(12) Patent Application Publication
(10) Pub. No.: US 2017/0059692 A1
(43) Pub. Date: Mar. 2, 2017

(54) Mitigation of Small Unmanned Aircraft Systems Threats

(71) Applicant: Laufer Wind Group LLC, New York, NY (US)

(72) Inventors: Eric David Laufer, New York, NY (US); John Knag, New Boston, NH (US); Rodney Petr, Acton, MA (US)

(21) Appl. No.: 15/248,337

(22) Filed: Aug. 26, 2016

Related U.S. Application Data
(60) Provisional application No. 62/211,319, filed on Aug. 28, 2015.
(60) Provisional application No. 62/352,728, filed on Jun. 21, 2016.

(51) Int. Cl. G01S 7/38

(52) U.S. Cl. CPC G01S 7/38

(57) ABSTRACT

Described are systems and methods for drone interdiction. A target aircraft is detected based on data from one or more of one or more radars, a fixed camera image from one or more fixed cameras, and an interceptor aircraft image from a camera mounted to an interceptor aircraft. An interception location is generated describing where the interceptor aircraft and the target aircraft are expected to meet. The interceptor aircraft is directed to the interception location to immobilize the target aircraft.

### CROSS-REFERENCES TO RELATED APPLICATIONS

This application claims the benefit of U.S. Patent Application No. 62/211,319, filed on Aug. 28, 2015, and titled “Drone Interdiction System,” and U.S. Patent Application No. 62/352,728, filed on Jun. 21, 2016, and titled “Mitigation of Small Unmanned Aircraft Systems (sUAS) Threats;” the entire contents of each are incorporated herein by reference.

### FIELD OF THE TECHNOLOGY

The present technology relates generally to the mitigation of threats from unmanned aircraft systems threats and, more specifically, to interdiction systems using one or more of radar, fixed cameras, and interceptor aircraft to mitigate such threats.

### BACKGROUND

Small unmanned aircraft systems (“sUAS”), such as radio-controlled drones or quadcopters, can pose a serious threat to civil aviation traffic and airspaces, ground installations, other high value assets, and large crowds. These sUAS can be easily obtained by recreational hobbyists and by those who seek to operate them for malicious purposes. The effective guidance and control capability of commercially-available sUAS as well as their capability for autonomous flight control features make these devices especially dangerous as standoff threats. Weapons or other dangerous instruments can be attached to the sUAS, further increasing the threat posed to sensitive locations. Swarm attacks involving multiple simultaneous sUAS threats are especially worrisome and present unique challenges.

Attempts to counter the threat posed by autonomous sUAS using radio frequency, for instance by detecting sUAS control signals, co-opting sUAS wireless communication links, or disrupting GPS signals by spoofing, can be ineffective in some situations. Recent improvements of the signal security of commercial GPS systems by adding digital signatures onto GPS civil navigation messages have made spoofing increasingly difficult. Similarly, approaches based on radio frequency disruption or control are becoming increasingly ineffective as attackers become more sophisticated. These radio frequency approaches can be ineffective against fully-autonomous sUAS. Accordingly, a need exists for an interdiction system to counter the threat posed by sUAS.

### SUMMARY OF THE TECHNOLOGY

Systems and methods are provided for the interdiction of sUAS systems, such as a drone, and other threats that can provide greater efficacy than spoofing approaches. In one aspect, there is a method for drone interdiction. The method can include detecting, using one or more radars, a target aircraft within a surveillance zone. The method can include generating first one or more interceptor aircraft commands to direct an interceptor aircraft to the target aircraft, based on data from the one or more radars. The method can include commanding the interceptor aircraft according to the first one or more interceptor aircraft commands. The method can include acquiring a target image using a camera mounted on the interceptor aircraft. The method can include, generating, in response to determining the target aircraft is in the target image, second one or more interceptor aircraft commands to direct the interceptor aircraft to the target aircraft, based on at least one of the target image, a fixed camera target image from one or more fixed cameras and the data from the one or more radars. The method can include commanding the interceptor aircraft according to the second one or more interceptor aircraft commands.

In some embodiments, the method can include tracking the target aircraft based on the fixed camera target image, a fixed camera system model, and the data from the one or more radars. In some embodiments, the method can include determining that the target aircraft is a threat. In some embodiments, the method can include determining that the target is a threat by analyzing the fixed camera target image. In some embodiments, the method can include commanding the interceptor aircraft to an interceptor aircraft base station in response to determining the target aircraft is not a threat.

In some embodiments, the method can include immobilizing, by the interceptor aircraft, the target aircraft. In some embodiments, the method can include immobilizing, by the interceptor aircraft, the target aircraft by the interceptor aircraft using a net assembly to immobilize the target aircraft. In some embodiments, the method can include immobilizing, by the interceptor aircraft, the target aircraft by the interceptor aircraft using a net gun to immobilize the target aircraft.

In another aspect, there is a method for drone interdiction. The method can include detecting, using one or more radars, a target aircraft within a surveillance zone. The method can include generating first one or more interceptor aircraft commands to direct an interceptor aircraft to the target aircraft, based on data from the one or more radars. The method can include commanding the interceptor aircraft according to the first one or more interceptor aircraft commands. The method can include acquiring a target image using a camera mounted on the interceptor aircraft. The method can include determining, in response to determining the target aircraft is in the target image, an interception location, based on at least one of the target image, a fixed camera target image from one or more fixed cameras and the data from the one or more radars. The method can include generating second one or more interceptor aircraft commands to direct the interceptor aircraft to the target aircraft, based on the interception location. The method can include commanding the interceptor aircraft according to the second one or more interceptor aircraft commands.

In some embodiments, determining, in response to determining the target aircraft is in the target image, an interception location, based on at least one of the target image, a fixed camera target image from one or more fixed cameras and the data from the one or more radars can include generating a first track state, based on the target image. In some embodiments, determining, in response to determining the target aircraft is in the target image, an interception location, based on at least one of the target image, a fixed camera target image from one or more fixed cameras and the data from the one or more radars can include generating a first track score, based on the first track state. In some embodiments, determining, in response to determining the target aircraft is in the target image, an interception location, based on at least one of the target image, a fixed camera target image from one or more fixed cameras and the data from the one or more radars can include generating a second track state, based on one or more of the fixed camera target image from the one or more fixed cameras and the data from the one or more radars. In some embodiments, determining, in response to determining the target aircraft is in the target image, an interception location, based on at least one of the target image, a fixed camera target image from one or more fixed cameras and the data from the one or more radars can include generating a second track score, based on the second track state. In some embodiments, determining, in response to determining the target aircraft is in the target image, an interception location, based on at least one of the target image, a fixed camera target image from one or more fixed cameras and the data from the one or more radars can include selecting the first track state or the second track state by comparing the first track score and the second track score.

In another aspect, there is a method for drone interdiction. The method can include detecting a target aircraft, based on data from one or more of one or more radars, a fixed camera image from one or more fixed cameras, and an interceptor aircraft image from a camera mounted to an interceptor aircraft. The method can include generating an interception location where the interceptor aircraft and the target aircraft are expected to meet. The method can include directing, based on the interception location, the interceptor aircraft to the interception location to immobilize the target aircraft. In some embodiments, directing, based on the interception location, the interceptor aircraft to the interception location to immobilize the target aircraft can include capturing the target aircraft using a hanging net. In some embodiments, directing, based on the interception location, the interceptor aircraft to the interception location to immobilize the target aircraft can include firing a net gun at the target to capture the target aircraft.

Other aspects and advantages of the present technology will become apparent from the following detailed description, taken in conjunction with the accompanying drawings, illustrating the principles of the technology by way of example only.

### BRIEF DESCRIPTION OF THE DRAWINGS

The foregoing and other objects, features, and advantages of the present technology, as well as the technology itself, will be more fully understood from the following description of various embodiments, when read together with the accompanying drawings, in which:

FIG. 1 illustrates an interdiction system in accordance with embodiments of the technology;

FIG. 2 illustrates a system diagram of a central controller in accordance with embodiments of the technology;

FIG. 3 illustrates a flow diagram of a method for interdiction in accordance with embodiments of the technology;

FIG. 4 illustrates a block control diagram of radar tracking according to embodiments of the technology;

FIG. 5 illustrates a block control diagram of video tracking in accordance embodiments of the technology;

FIG. 6 illustrates a block control diagram of radar and video tracking in accordance with embodiments of the technology;

FIG. 7 illustrates block control diagrams for two axes of an interceptor aircraft on final approach to a target in accordance with embodiments of the technology;

FIG. 8 illustrates a block control diagram for an axis of an interceptor aircraft on final approach to a target in accordance with embodiments of the technology.

### DETAILED DESCRIPTION

The interdiction systems and methods described herein can offer improved real-time monitoring and interception capabilities over other methods of sUAS interdiction. The use of multiple modes of detection, including, for example, distributed radar, fixed camera sensors, and distributed interceptor aircraft can provide a flexible and rapid sUAS mitigation response to reliably identify, capture, and defeat sUAS and swarm threats. The interdiction systems and methods described herein can lead to faster response and verification times, as well as improve the time between when the sUAS threat is detected and when it is immobilized. Immobilizing or capturing sUAS threats intact can advantageously improve the likelihood that the sUAS operator can be identified and held accountable.

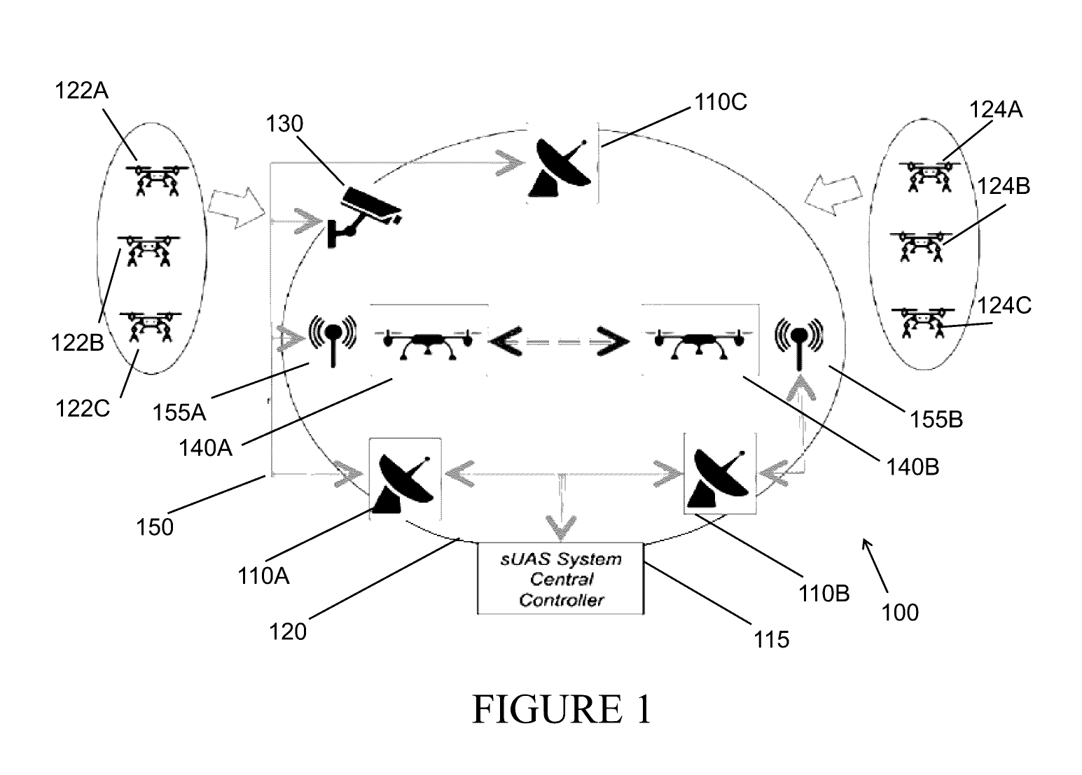

FIG. 1 illustrates interdiction system 100 in accordance with embodiments of the technology. Doppler radars 110A-110C are distributed throughout an area, such as an area including a high value asset that requires protection. Data from Doppler radars 110A-110C is transmitted to and monitored by central controller 115. Doppler radars 110A-110C can receive control or other signals from central controller 115. In some embodiments, central controller 115 can fuse track output from an individual Doppler radar, such as Doppler radar 110A, with track output from another individual Doppler radar, such as Doppler radar 110B, to create a wider coverage area.

Surveillance zone 120 represents the area that is monitored and protected from the threat of incoming sUAS, like drones 122A-122C and 124A-124C. In some embodiments, the coverage of Doppler radars 110A-110C can define surveillance zone 120. In other embodiments, each of Doppler radars 110A-110C can individually define its own surveillance zone. The number of Doppler radars used in an interdiction system can be based on the desired size of the surveillance zone as well as the coverage area of each individual Doppler radar. Longer range detection can be achieved by increasing transmit power of radars 110A-110C, or by increasing antenna gain of radars 110A-110C. Doppler radars 110A-110C can be, for example, Laufer Wind MD-12 Doppler radars produced by Laufer Wind of New York, N.Y., though other types of radars can be used in accordance with the technology. Radars of this type can detect and track small targets with a radar cross section (“RCS”) of less than 0.03 square meters, for example, birds and small sUAS, to ranges up to four kilometers.

Fixed camera 130 monitors surveillance zone 120. Fixed camera 130 can be disposed at a fixed location in surveillance zone 120 and can be capable of tilting and panning by a gimbal. In some embodiments, fixed camera 130 can be a plurality of fixed cameras distributed along the perimeter of surveillance zone 120. In some embodiments, the coverage range of fixed camera 130 can define surveillance zone 120. Fixed camera 130 can be mounted above the ground, for example 20 feet from the ground or at a height that can surmount nearby obstacles such as trees and buildings. In some embodiments, there may be multiple fixed cameras, to increase the coverage area of the fixed cameras or improve resolution of images captured by utilizing the nearest camera. Fixed camera 130 can acquire images of targets and track targets at a shorter range than radars 110A-110C, for example a range of less than 500 meters. In some embodiments, fixed camera 130 is cued or pointed in the direction of a target by central controller 115 based on track data from radars 110A-110C. Fixed camera 130 can transmit video and/or image data to central controller 115. Images from fixed camera 130 can be used to discriminate between targets that present a threat, such as drones 122A-122C and 124A-124C, and targets that do not present a threat, such as birds or random ground clutter. In some embodiments, a user can verify a threat based on a video or still image feed from fixed camera 130. In other embodiments, central controller 115 can analyze images captured by fixed camera 130 to verify whether an object is a threat automatically. In some embodiments, images captured by fixed camera 130 can be analyzed by a processor collocated with fixed camera 130. Fixed camera 130 can capture video or images in the visible spectrum, in the infrared (IR) spectrum, or both. In some embodiments, the field of view (“FOV”) of fixed camera 130 can be selected based on the angular accuracy of radars 110A-110C and optics of fixed camera 130. For example, where the angular resolution of the radar is +/−0.2 degrees, the minimum fixed camera FOV can be 4 degrees. Fixed camera 130 can have a zoom lens, which can have a wider FOV at a lower zoom, as compared with a higher zoom. In some embodiments, fixed camera 130 can require an FOV that is, for example, five times larger, than the angular resolution of radars 110A-110C.

Interceptor aircraft 140A-140B are distributed in surveillance zone 120. Interceptor aircraft 140A-140B can be, for example quadcopter drones. Interceptor aircraft 140A-140B can be approximately 105 centimeters square by 30 centimeters high. The dimensions of interceptor aircraft 140A-140B can vary depending on the application, including, for example, using a smaller interceptor aircraft where a smaller surveillance zone is desired or a larger interceptor aircraft where a larger surveillance zone is required. Interceptor aircraft 140A-140B can be, for example, a quadcopter, or an octocopter, such as the DJI S1000+. In some embodiments, there can be only one interceptor aircraft per surveillance zone 120. In other embodiments, two or more interceptor aircraft can be used, depending on the size of the surveillance zone and the desired time of response of the interceptor aircraft. In some embodiments, each interceptor aircraft can intercept its own target, such as in the event of a swarm attack with multiple target sUAS. Interceptor aircraft 140A-140B can be distributed at regular intervals throughout surveillance zone 120 to minimize the time between when a target, such as drones 122A-122C and 124A-124C, is detected by interdiction system 100 and when it is intercepted and immobilized by one or more of interceptor aircraft 140A-140B.

Interceptor aircraft 140A-140B can transmit video or image data or other information detected about its operational state, including, for example, pitch, yaw, or rotor power, via a wireless connection to central controller 115. Interceptor aircraft 140A-140B can include inertial measurement units (“IMUs”) that include sensors to measure various parameters of the flight of interceptor aircraft 140A-140B. For example, the IMU can include rate gyros and accelerometers for measuring the acceleration of interceptor aircraft 140A-140B and angular rates (e.g., roll, pitch, and yaw) of interceptor aircraft 140A-140B. Interceptor aircraft 140A-140B can receive command data via a wireless connection from central controller 115. In some embodiments, a user can manually override control of interceptor aircraft 140A-140B by central controller 115 and pilot interceptor aircraft 140A-140B via manual input.

Interceptor aircraft 140A-140B include an on-board camera, capable of capturing video or images in the visible spectrum, IR spectrum, or both. In some embodiments, the on-board camera can have a range of up to 75 meters and can have six times zoom capability. The on-board camera can have an FOV capable of compensating for any angular accuracy deficiencies of radars 110A-110C, for example, a 4 degree FOV. The on-board camera can have a zoom lens, which can have a wider FOV at a lower zoom, as compared with a higher zoom. In some embodiments, interceptor aircraft 140A-140B can use an on-board camera to verify whether an object, such as drones 122A-122C and 124A-124C, presents a threat. Central controller 115 can determine whether objects detected by the cameras mounted to interceptor aircraft 140A-140B pose a threat, such as drones 122A-122C and 124A-124C or whether they do not, such as birds or miscellaneous ground clutter. Where interdiction system 100 determines that the tracked object shown in the image acquired by cameras mounted to interceptor aircraft 140A-140B is not a threat, it can command interceptor aircraft 140A-140B to return to an interceptor aircraft base station.

In some embodiments, interceptor aircraft 140A-140B can be capable of a maximum flight speed of 30-45 miles per hour. Interceptor aircraft 140A-140B can be located at interceptor aircraft base stations, not depicted, when not in use. In some embodiments, interceptor aircraft 140A-140B are capable of a flight time of fifteen minutes or longer before requiring charging. In some embodiments, interceptor aircraft 140A-140B are capable of carrying a payload capacity of up to six kilograms.

In some embodiments, interceptor aircraft 140A-140B include hanging nets to intercept, disrupt the flight of, and/or capture sUAS targets, such as drones 122A-122C and 124A-124C. In other embodiments, interceptor aircraft 140A-140B include mounted net guns that can be fired at a sUAS target. The net gun can include a net gun housing and a net propulsion barrel that cooperate to propel a net toward a target with the aid of, for example, a high pressure carbon dioxide canister. The net gun can fire, for example, a square net that is eight feet by eight feet by two inches square in dimension. The net gun can propel a net at a nominal velocity of, for example, thirty feet per second, with a range of thirty feet. Net guns can be advantageous because they minimize drag and energy dissipation of interception drones 140A-140B during flight. In some embodiments, central controller 115 can control the firing of the net gun. In some embodiments, a computer on interceptor aircraft 140A-140B can control the firing of the net gun.

Central controller 115 of interdiction system 100 can transmit and receive data from each of the components of interdiction system 100, including, for example, Doppler radars 110A-110C, fixed camera 130, and interceptor aircraft 140A-140B. Central controller 115 connects with these components through network 150, which can be, for example, an encrypted managed-UDP (user datagram protocol) wide area network. In some embodiments, central controller 115 is connected to stationary components of interdiction system 100 by a wired connection, for example 10/100 and Gigabit Ethernet connections. Central controller 115 can be connected to interceptor aircraft 140A-140B through a wireless connection. The wireless connection can be established by RF receivers 155A-155B connected to central controller 115 that interfaces with a radio modem, for example a 900 MHz radio modem, on interceptor aircraft 140A-140B. In other embodiments, central controller 115 can be connected to all components through wireless connections. In some embodiments, central controller 115 can monitor the health of one or more of radars 110A-110C, fixed camera 130, and interceptor aircraft 140A-140B. In some embodiments, central controller 115 can be a rack-mounted computer. In other embodiments, central controller 115 can be a ruggedized unit for outdoor operation. Central controller 115 can be capable of simultaneously tracking more than thirty targets in surveillance zone 120.

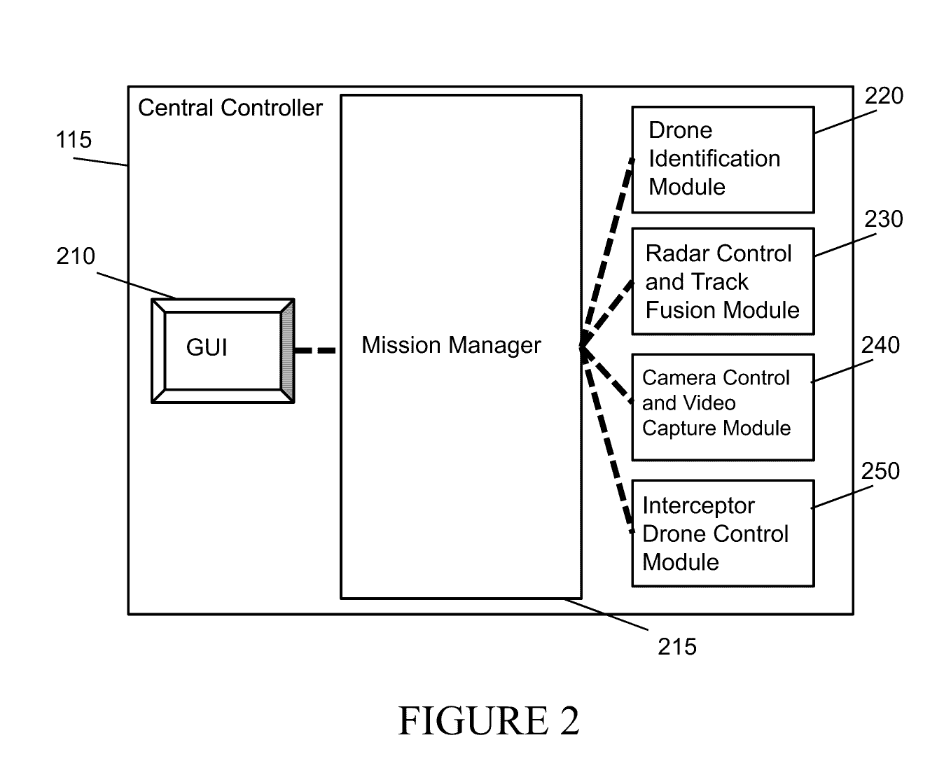

FIG. 2 illustrates a system diagram of central controller 115 in accordance with embodiments of the technology. Central controller 115 can include software and hardware components for controlling interdiction system 100. Central controller 115 can include graphical user interface (“GUI”) 210. GUI 210 can display real-time tracking maps and information based on, for example, signals and information received from radars 110A-110C, fixed camera 130, and/or cameras mounted on interceptor aircraft 140A-140B. GUI 210 can accept user input, for example where a user desires to manually override flight controls of interceptor aircraft 140A-140B. Central controller 115 includes Mission Manager 215. Mission Manager 215 includes modules for controlling interdiction system 100. Drone identification module 220 permits central controller 115 to positively detect targets as threats. Drone identification module 220 can use video or image data from fixed camera 130 and/or cameras mounted on interceptor aircraft 140A-140B and/or data from radars 110A-110C to determine whether a detected target exhibits characteristics that would indicate it was a threat. Machine learning algorithms, for example Deep Convolutional Neural Network architectures such as those available from OpenCV or TensorFlow, can be used to classify whether a target is a threat or not. In some embodiments, the machine learning algorithms can determine whether a target is a drone, and if the target is a drone, whether it is a threat.

Mission manager 215 includes radar control and track fusion module 230. Radar control and track fusion module 230 provides control parameters to radars 110A-110C of interdiction system 100. Radar control and track fusion module 230 can use software available from Laufer Wind. Radar control and track fusion module 230 fuses data from radars 110A-110C to increase the size of surveillance zone 120. Radar control and track fusion module 230 can determine which of radars 110A-110C provide the highest likelihood of accurately locating a target, for example by using a predictor/corrector filtering, such as alpha/beta filtering or kalman filtering, to correct for inaccuracies. In some embodiments, radar control and track fusion module 230 can fuse data by generating a track score for each tracked target. The track score can be based on certain attributes of the tracked target, such as strength of the signal return, or the time last detected, to resolve the most accurate track for the target. In some embodiments, radar control and track fusion module 230 can fuse data from radars 110A-110C or additional radars to extend the size of surveillance zone 120 of interdiction system 100.

Mission manager 215 includes camera control and video capture module 240. Camera control and video capture module 240 provides control for fixed camera 130 and cameras mounted to drones 140A-140B, for example directional control. Camera control and video capture module 240 can provide control for fixed camera 130 and cameras mounted to drones 140A-140B based on data from those cameras and/or data from radars 110A-110C. Camera control and video capture module 240 can control parameters of video capture performed by fixed camera 130 and cameras mounted to drones 140A-140B. For example, camera control and video capture module 240 can set the frame rate for video capture, which can be, for example, 30 Hz or 60 Hz.

Mission Manager 215 includes interceptor aircraft control module 250. Interceptor aircraft control module 250 can use data from radar control and track fusion module 230 and/or camera control and video capture module 240 to generate commands and control interceptor aircrafts 140A-140B to intercept and immobilize a target, such as drones 122A-122C and 124A-124C. In some embodiments, interceptor aircraft control module 250 can use software such as Dronecode APM Planner or DJI Guidance SDK to facilitate control of interceptor aircrafts 140A-140B.

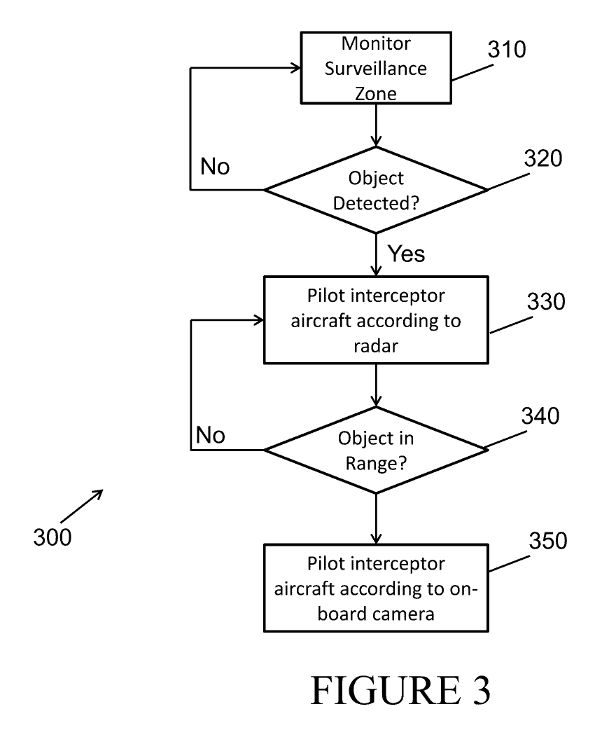

FIG. 3 illustrates a flow diagram of a method for interdiction in accordance with embodiments of the technology. Interdiction method 300 can be performed by, for example, the components of interdiction system 100. At step 310, the components of the interdiction system, for example radars or fixed cameras, monitor the surveillance area, for example surveillance zone 120. At step 320, interdiction method 300 determines whether an object has been detected. Central controller 115 can process signals from radars 110A-110C to determine whether an object has been detected. In some embodiments, central controller 115 can process images or video from fixed camera 130 or a patrolling interceptor aircraft to determine whether an object has been detected. If the interdiction system does not detect any objects in the surveillance zone, the method returns to step 310 to continue monitoring the surveillance zone.

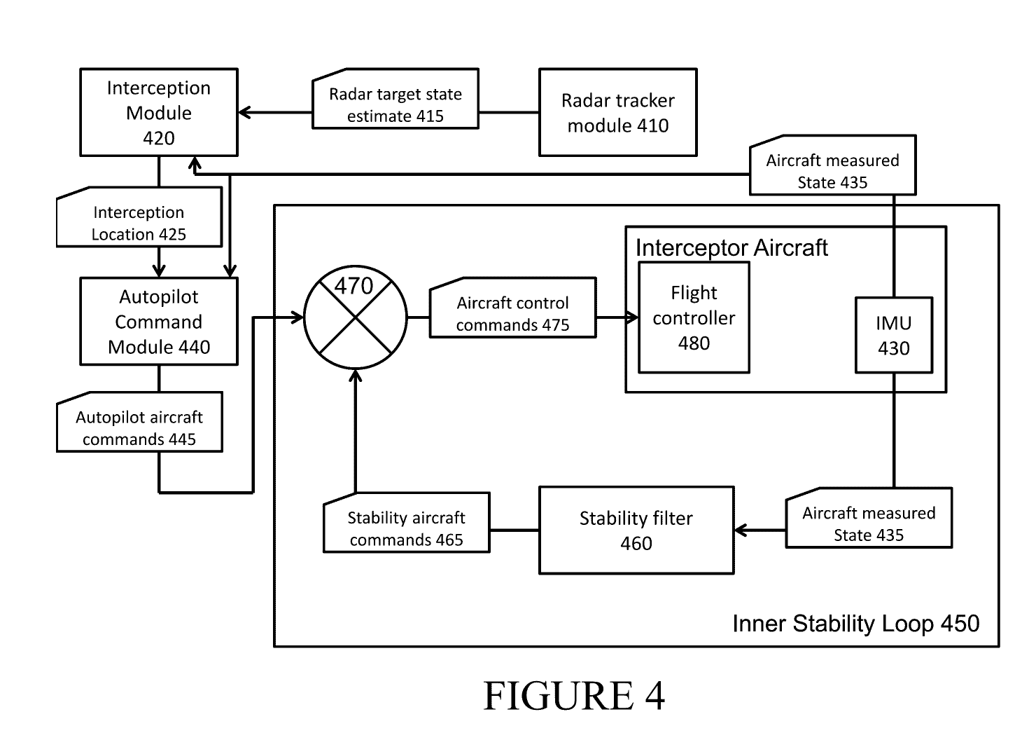

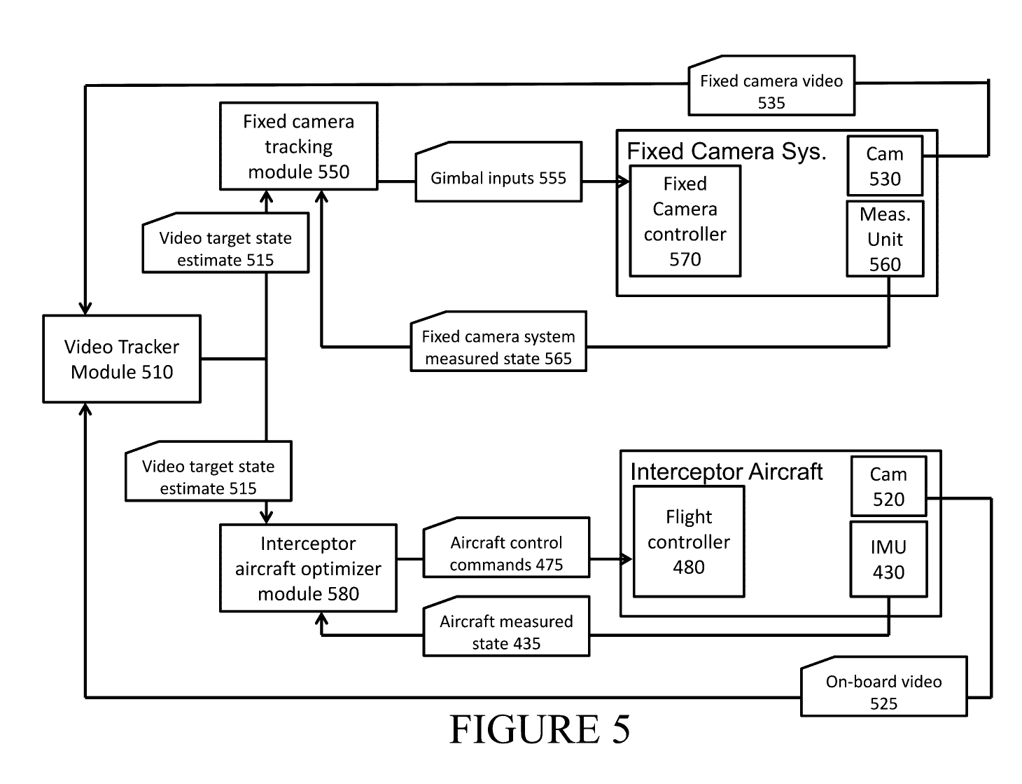

When interdiction method 300 detects an object in step 320, the interdiction system pilots the interceptor aircraft toward the target in step 330. Central controller 115 can use a radar tracker, in conjunction with an interception model, to determine a location where the interceptor aircraft can intercept the target. Central controller 115 can generate commands to pilot the interceptor aircraft to an expected interception location, as described in greater detail with respect to FIG. 4. Interdiction method 300 includes determining whether an object is within range of a camera mounted to an interceptor aircraft, such as interceptor aircraft 140A-140B, in step 340. In some embodiments, the range of the interceptor aircraft-mounted camera can be 75 meters. Where the object detected is not in range at step 340, interdiction method 300 continues piloting the interceptor aircraft toward the calculated interception location in accordance with radar signals, at step 330. If the object detected is in range at step 340, interdiction method 300 ceases piloting the interceptor aircraft according to the radar track information and begins piloting the interceptor aircraft based on video or images from a camera mounted to the interceptor aircraft, in step 350, as described in further detail with respect to FIG. 5. In some embodiments, interceptor aircraft includes a net gun, and the interdiction method includes the additional steps of determining whether the net gun is in range and firing the net gun in the direction of a target to immobilize the target. In some embodiments, once the object is determined to be in range at step 340, the generation of commands to pilot the interceptor aircraft can be performed on-board the interceptor aircraft, without the aid of a central controller.

In some embodiments, central controller 115 can use a video or image acquired from a fixed camera, such as fixed camera 130, to verify whether a detected object is a threat, for example by comparing a threat profile against the image detected by the fixed camera. If the object is determined not to be a threat, interdiction method 300 is stopped. In some embodiments, verification of whether an object is a threat can be performed by central controller 115 according to signals from radars 110A-110C, or from cameras mounted to interceptor aircraft 140A-140B. In other embodiments, a user monitoring interdiction method 300 can manually override the controls of interceptor aircraft 140A-140B by an interface through central controller 115, for example through GUI 210.

FIG. 4 illustrates a block control diagram of radar tracking according to embodiments of the technology. Radars 110A-110C can detect an object within surveillance zone 120. When an object is first detected, as in step 320 shown in FIG. 3, central controller 115 can track the motion of a target within surveillance zone 120 using signals reflected from an object and detected by a radar, such as radars 110A-110C. Central controller 115 can use radar tracker module 410 to generate a radar target state estimate 415 from signals detected by the radar monitoring surveillance zone 120. Radar target state estimate 415 can include information about a detected object's position, velocity, and/or acceleration. In some embodiments, radar tracker module 410 can be a part of radar control and track fusion module 230 of central controller 115. In other embodiments, radar tracker module 410 can be a part of a radar unit.

Central controller 115 uses interception module 420 to generate an interception location 425 based on an interceptor aircraft dynamics model and a radar target model. The interceptor aircraft dynamics model can be an equation that accounts for attributes of the interceptor aircraft, such as interceptor aircraft 140A-140B, including flight characteristics and capabilities and aerodynamic properties, such as the effects of control surfaces, rates of differential motor torques, and/or the collective motor torques. The interceptor aircraft dynamics model can also incorporate aircraft measured state 435, which can include data about the current flight conditions of the interceptor aircraft, measured by IMU 430 of the interceptor aircraft. The radar target model can be an equation that accounts for the known or expected attributes of the detected object, which can be, for example, drones 122A-122C or drones 124A-124C. The radar target model can incorporate radar target state estimate 415 from radar tracker module 410. Central controller 115 can use interception module 420 to determine the location at which the interceptor aircraft dynamics model and the target model predict the target and the interceptor aircraft will intersect, which is output as interception location 425. In some embodiments, the interceptor aircraft dynamics model can update at a rate of 30 Hz or a rate of 60 Hz, based on the refresh rate of IMU 430 generating aircraft measured state 435. In some embodiments, the target model can update at a rate of 0.3 Hz, based on the radar scan cycle.

Central controller 115 uses autopilot command module 440 to generate autopilot aircraft commands 445 based on interception location 425 and the interceptor aircraft dynamics model. Central controller 115 uses autopilot command module 440 to solve for the set of autopilot aircraft commands 445 to cause the interceptor aircraft to fly to interception location 425. The set of autopilot aircraft commands 445 can include, for example, a yaw command, pitch command, and/or motor speed commands. In some embodiments, autopilot command module 440 can solve for the set of autopilot aircraft commands 445 to pilot an interceptor aircraft to interception location 425 using a matrix-type approach to determine all of the commands collectively. In other embodiments, autopilot command module 440 can calculate the command for each axis separately. In some embodiments, interceptor aircraft dynamics model can be a collection of models, where each model accounts for differences based upon certain flight conditions. For example, there may be different interceptor aircraft dynamics models where an interceptor aircraft is flying at a comparatively higher speed, such as at the interceptor aircraft's maximum speed, or a comparatively lower rate of speed.

An updated interception location 425 can be generated each time radar target state estimate 415 is updated, for example at the refresh rate of radars 110A-C and/or as quickly as the refresh rate of aircraft measured state 435 information provided by IMU 430 about the flight of the interceptor aircraft. Inner stability loop 450 can facilitate the interceptor aircraft maintaining level flight. Inner stability loop 450 can be performed by a computer on-board the interceptor aircraft. IMU 430 of the interceptor aircraft generates aircraft measured state 435 based on information detected about the interceptor aircraft's current flight conditions. Inner stability loop 450 uses stability filter 460 to generate stability aircraft commands 465 that are intended to correct for disturbances encountered by the interceptor aircraft during flight, for example, impact by small objects, wind disturbances, or any other irregularities. Stability filter 460 can include, for example, a rate feedback or lagged rate feedback filter, which can calculate stability aircraft commands 465 on a per-axis basis according to aircraft measured state 435 and an interceptor aircraft dynamics model. In other embodiments, stability filter 460 can be a model following filter. Stability filter 460 outputs stability aircraft commands 465, for example a yaw command, pitch command, or rotor power command, to maintain the interceptor aircraft in an upright position. Inner stability loop 450 uses command summer 470 which sums autopilot aircraft commands 445 and stability aircraft commands 465 to generate aircraft control commands 475. Aircraft control commands 475 are used by interceptor aircraft flight controller 480 to pilot the interceptor aircraft toward interception location 425, for example, as in step 330.

FIG. 5 illustrates a block control diagram of video tracking in accordance embodiments of the technology. When an object, such as drones 122A-122C or drones 124A-124C, is determined to be within the range of a camera mounted to the interceptor aircraft, for example as in step 340 of interdiction method 300, the interceptor aircraft can be piloted according to the image or video data acquired by the on-board camera, for example as in step 350 of interdiction method 300. Central controller 115 uses video tracker module 510 to track detected objects using on-board video 525 and/or fixed camera video 535. In some embodiments, on-board video 525 and/or fixed camera video 535 can be an image or images of the target. Based on on-board video 525 and/or fixed camera video 535, video tracker module 510 can generate video target state estimate 515. Video target state estimate 515 can include information about a target's detected position, velocity, and/or acceleration, based on on-board video 525 or fixed camera video 535. Central controller 115 uses video tracker module 510 to process on-board video 525 or fixed camera video 535 and acquire an image or video of the tracked object against the background of each frame of the respective on-board video 525 or fixed camera video 535. In some embodiments, video tracker module 510 employs centroid tracking or correlation tracking based on the position of each target within each frame of on-board video 525 or fixed camera video 535 to track the position of the detected object. In some embodiments, on-board video 525 or fixed camera video 535 can be an image of the target. In some embodiments, there can be separate video trackers for on-board video 525 and for fixed camera video 535. In other embodiments, the video tracking performed by video tracker 510 for on-board video 525 is performed on a computer on-board the interceptor aircraft.

Fixed camera tracking module 550 is used by central controller 115 to generate gimbal inputs 555. Central controller 115 calculates gimbal inputs 555 with fixed camera tracking module 550 based on a video target model and a fixed camera system model. The video target model can be an equation that accounts for the known or expected attributes, such as size or flight characteristics, of the detected object, incorporating video target state estimate 515. The fixed camera system model can be an equation that accounts for the dynamics of the fixed camera system. For example, the fixed camera system model can reflect servo dynamics and/or inertia of the gimbal of the fixed camera system and can reflect structural dynamics of a fixed support structure on which the gimbal camera is mounted. The fixed camera system can use fixed camera measurement unit 560 to measure current conditions of the fixed camera system and generate fixed camera system measured state 565. The fixed camera system model incorporates fixed camera system measured state 565, describing, for example, current position, current orientation, and current motion of the fixed camera system. Central controller 115 can use fixed camera tracking module 550 to determine gimbal inputs 555 to cause fixed camera 530 to point at a tracked object. For example, fixed camera tracking module 550 can use Newton's Method or the Broyden-Fletcher-Goldfarb-Shanno (“BFGS”) algorithm, or a similar method, to determine the set of gimbal inputs 555 based on the fixed camera system model and the video target model. Fixed camera controller 570 uses gimbal inputs 555 to cause fixed camera 530 to pan, tilt, or zoom to track the detected object. In some embodiments, video tracker module 510 can use fixed camera system measured state 565 to improve the performance of tracking a detected object.

Central controller 115 uses interceptor aircraft optimizer module 580 to generate aircraft control commands 475. Interceptor aircraft optimizer module 580 calculates aircraft control commands 475 based on the video target model and an interceptor aircraft dynamics model. Interceptor aircraft dynamics model can incorporate aircraft measured state 435 from IMU 430. The video target model can be an equation that accounts for the known or expected attributes, such as size or flight characteristics, of the detected object and incorporates video target state estimate 515. Central controller 115 uses interceptor aircraft optimizer module 580 can predict the interception location where the interceptor aircraft will meet the target. In some embodiments, interceptor aircraft dynamics model and video target model are solved as a system of linear equations by interceptor aircraft optimizer module 580 to establish an interception location where the paths of the interceptor aircraft and the detected target can be expected to intercept. In other embodiments, interceptor aircraft optimizer module 580 can use Newton's Method or the Broyden-Fletcher-Goldfarb-Shanno (“BFGS”) algorithm, or a similar method, to determine the set of aircraft control commands 475 that can be used to pilot the interceptor aircraft toward a target. In some embodiments, video tracker module 510 can use aircraft measured state 435 to improve the performance of tracking a detected object. In some embodiments, interceptor aircraft optimizer module 580 can use video target state estimate 515 to determine whether a detected object, such as drones 122A-122C or drones 124A-124C, are in range of a net gun mounted to the interceptor aircraft and/or whether the interceptor aircraft is pointed at the target. Interceptor aircraft optimizer module 580 can generate a command to cause the interceptor aircraft to fire the net gun to immobilize the target. In some embodiments, interceptor aircraft optimizer module 580 can be a part of central controller 115, for example as part of interceptor aircraft control module 250. In some embodiments, interceptor aircraft optimizer module 580 can be a part of a computer on-board the interceptor aircraft.

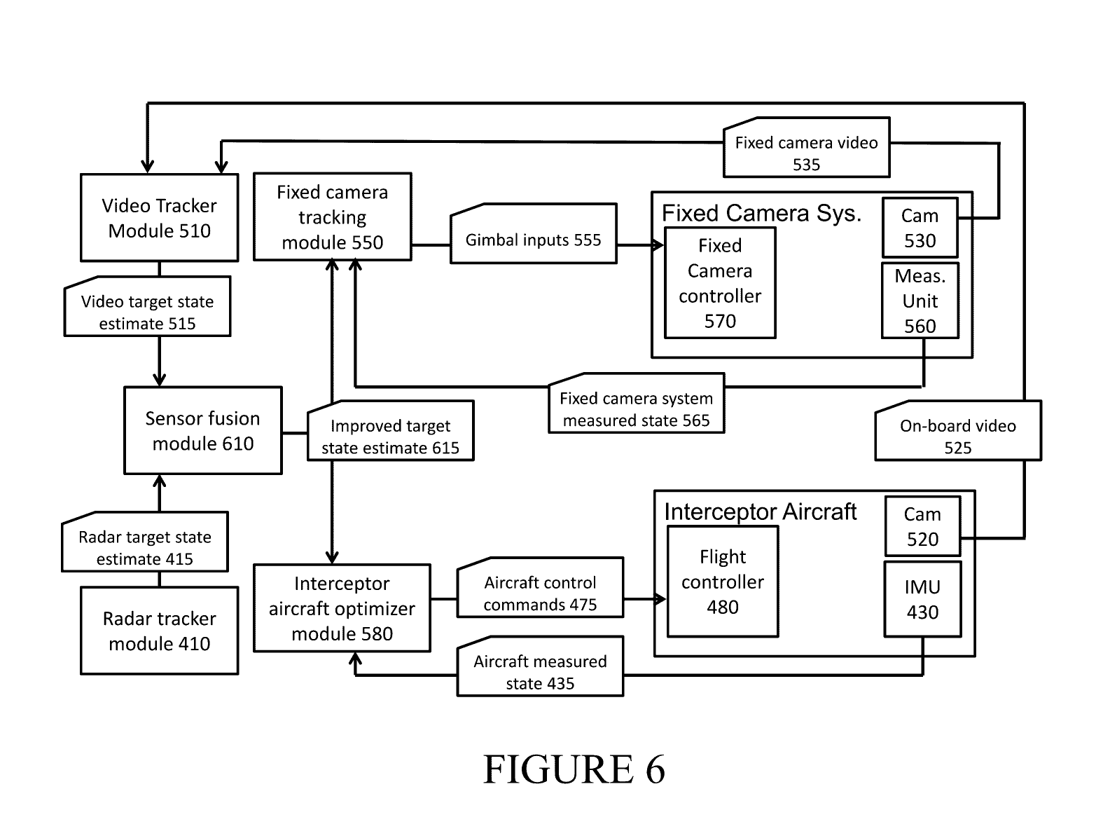

FIG. 6 illustrates a block control diagram of radar and video tracking in accordance with embodiments of the technology. Central controller 115 can generate improved target state estimate 615 using sensor fusion module 610. Sensor fusion module 610 receives video target state estimate 515 from video tracker module 510 and radar target state estimate 415 from radar tracker module 410. In some embodiments, there may be more than one video target state estimate or radar target state estimate. Sensor fusion module 610 can generate a track score for each input, such as video target state estimate 515 and radar target state estimate 415. Track scores can be developed for a target state estimate based on a log-likelihood ratio using both the target state estimate as well as target state estimate attribute probabilities in the manner described by Blackman and Popoli (Design and Analysis of Modern Tracking Systems. Blackman, Samuel and Popoli, Robert. Artech House 1999. p. 328-330). A target state estimate can consist of the target position and its first derivatives. A target state estimate attribute for the radar track can include signal-to-noise ratio (“SNR”), scalar speed, heading, heading rate, and the area of the target detection in range-Doppler space. Track attributes for optical tracking can include, for example, include SNR, scalar speed, heading, heading rate, and color.

Tracks can be fused in an asynchronous manner whenever a track update is received from either radar tracker module 410 or video tracker module 510. At each update, the track scores of the two can be compared by sensor fusion module 610, and the track with the better score is used as to update the fused track. Track updates with measurements are filtered using a Kalman filter by sensor fusion module 610 to generate the improved target state estimate 615. The track scores can normalized using the measurement and attribute covariances. Since the tracks are updating asynchronously, the normalization factor in the track score (the inverse of the square root of the determinant of the measurement and attribute covariance matrix) can be predicted up to the current time using the same kinematic model and process noise used in the Kalman filter. The track score update can be described by the equation provided by Blackman and Popoli:

$$Δ L = ln ( \frac{{V}_{c}}{\sqrt{\vert S \vert}} ) - ln ( \frac{M ln ( 2 π ) + {d}^{2}}{2} ) + ln ( \frac{{P}_{d}}{{P}_{fa}} ) + ln ( \frac{p ( {y}_{s} \vert Det , {H}_{1} )}{p ( {y}_{s} \vert Det , {H}_{0} )} )$$

but for a non-updating track, S, d, and p(yₛ) are decayed by the time increment:

S_{decayed}=H(FPF^{T}+GQG^{T})H^{T}+R

Where H is the measurement matrix, F is the kinematic matrix (which includes the time increment), P is the covariance matrix of the measurements, G is the state transition matrix, Q is the process noise and R is the measurement variances. Similarly, the covariance of the residual for the signal attributes is decayed using a model of their kinematics, transitions and covariances. d is the Mahalanobis distance, which also includes S_{decayed}. In this way the track scores can be normalized for their disparate attributes as well as their asynchronous updates, and at every update the better scored track can be determined by sensor fusion module 610 and used to generate improved target state estimate 615.

Once improved target state estimate 615 is generated by sensor fusion module 610, fixed camera tracking module 550 and interceptor aircraft optimizer module 580 can use improved target state estimate 615 in the same manner as described with respect to target state estimate 515 in FIG. 5. The use of improved target state estimate 615 can enable more accurate tracking of a detected object, such as drones 122A-122C or drones 124A-124C. In particular, the use of improved target state 615 takes advantage of the plurality of sensors that are used in interdiction system 100 or interdiction method 300.

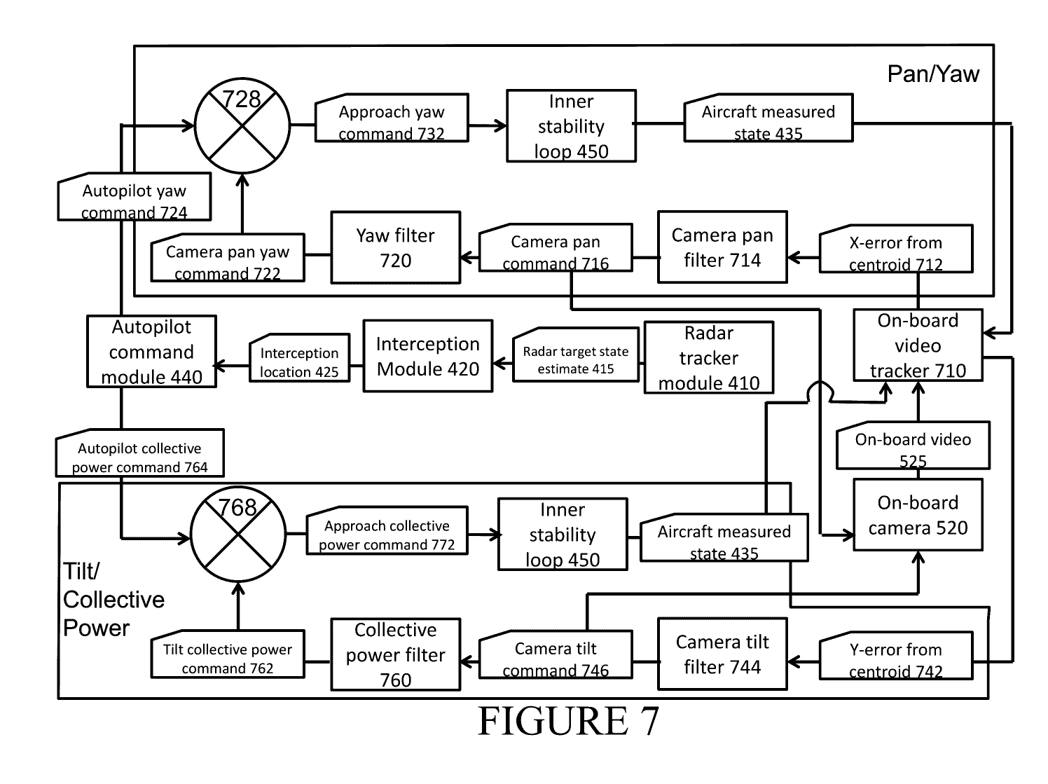

FIG. 7 illustrates block control diagrams for two axes of an interceptor aircraft on final approach to a target in accordance with embodiments of the technology. On final approach, the interceptor aircraft can rely more heavily on cameras mounted to the interceptor aircraft, such as on-board camera 520, to track the detected object and pilot the interceptor aircraft. In some embodiments, video tracking of a detected object does not begin until the detected object is in range, such as at step 340. In other embodiments, video tracking of a detected object is used exclusively once a target is within range. As shown in FIG. 7, on-board video tracker 710 can process on-board video 525 from on-board camera 520. On-board video tracker 710 outputs x-error from centroid 712, which reflects the distance along the x-axis or horizontal axis that a detected object is from the center of a frame of on-board video 525. Camera pan filter 714 processes x-error from centroid 712 to generate camera pan command 716. Camera pan filter 714 generates camera pan command 716 by determining the pan distance or pan angle that would be required to change the direction of on-board camera 520 to be pointed at the detected object. The direction of on-board camera 520 is controlled according to camera pan command 716. Yaw filter 720 receives camera pan command 716 from camera pan filter 714 and generates camera pan yaw command 722. Yaw filter 720 includes a model correlating the amount of pan dictated by camera pan command 716 with the amount of interceptor aircraft yaw that would be required to orient the tracked object at the centroid of a frame of on-board video 525 when on-board camera 520 is not panned, or is at zero degrees of pan from its central position. Yaw summer 728 sums camera pan yaw command 722 and autopilot yaw command 724 to generate an approach yaw command 732. Inner stability loop 450 can use approach yaw command 732, for example by flight controller 480, to control the interceptor aircraft yaw to pilot the interceptor aircraft in the direction of the tracked object. Autopilot yaw command 724 can be, for example, a portion of autopilot aircraft commands 445 corresponding to a single axis.

On-board video tracker 710 also generates y-error from centroid 742, which reflects the distance along the y-axis or vertical axis that a detected object is from the center of a frame of on-board video 525. Camera tilt filter 744 generates camera tilt command 746 by determining the tilt distance or tilt angle that would be required to change the direction of the on-board camera 520 to be pointed at the detected object. The direction of on-board camera 520 is controlled according to camera tilt command 746. Collective power filter 760 includes a model correlating the amount of tilt dictated by camera tilt command 746 with the amount of interceptor aircraft collective rotor power, which can dictate the height or altitude of the interceptor aircraft, that would be required to orient the tracked object at the centroid of a frame of on-board video 525 if the on-board camera 520 is not tilted, or is at zero degrees of tilt from its central position. Collective power summer 768 sums camera tilt collective power command 762 and autopilot collective power command 764 to generate an approach collective power command 772. Inner stability loop 450 can use approach collective power command 772 to pilot the interceptor aircraft in the direction of the tracked object. Autopilot collective power command 764 can be, for example, a portion of autopilot aircraft commands 445 corresponding to a single axis. In some embodiments, such as where an interceptor aircraft is using a passive net hanging from the interceptor aircraft to immobilize a target, central controller 115 can modify approach collective power command 772 such that the interceptor aircraft will be just above the tracked target so that it can interdict and immobilize the target. In some embodiments, incorporating flight commands according to on-board camera 520 does not occur until a target is in range, which can be controlled, for example, by a switch that controls whether camera pan yaw command 722 or tilt collective power command 762 reach yaw summer 728 or collective power summer 768. The switch can be controlled by central controller 115 or by a computer on-board the interceptor aircraft.

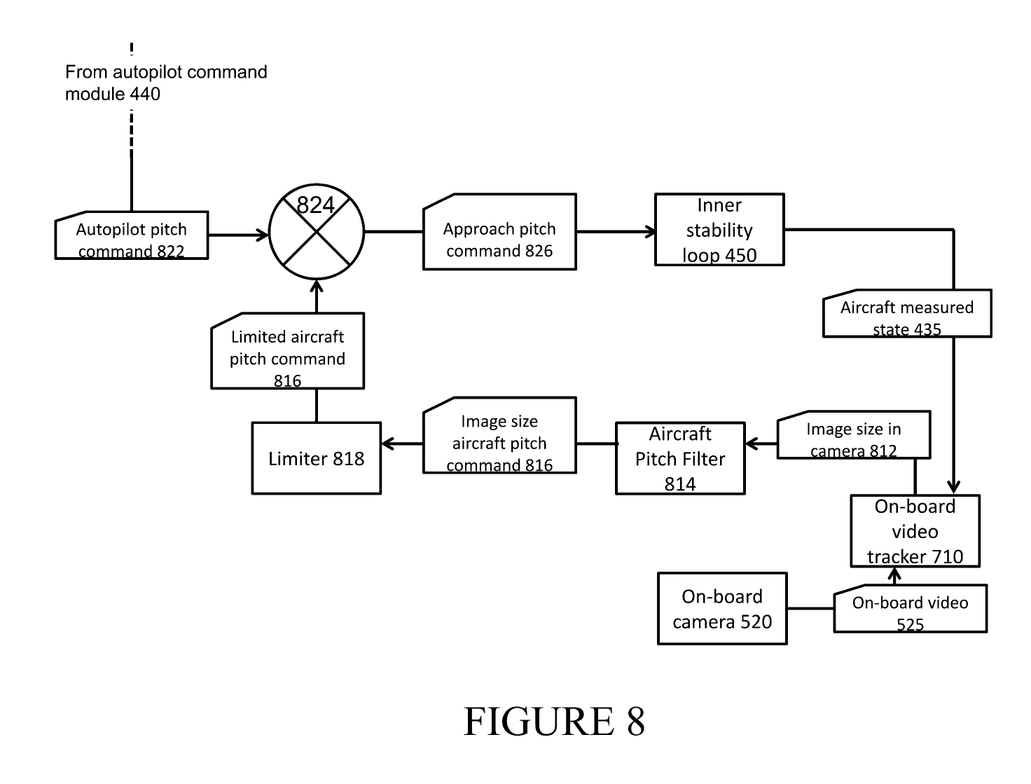

FIG. 8 illustrates a block control diagram for an axis of an interceptor aircraft on final approach to a target in accordance with embodiments of the technology. On-board video tracker 710 can generate image size in camera 812, which reflects the size of the detected object in a frame of on-board video 525. Aircraft pitch filter 814 uses image size in camera 812 to generate image size aircraft pitch command 816. Image size aircraft pitch command 816 reflects the amount of aircraft pitch would be required to cause the detected object image to take up a greater percentage of a frame of on-board video 525 in a subsequent frame. The pitch of an interceptor aircraft, like a quadcopter, is associated with its velocity, with the interceptor aircraft with a greater angle pitch traveling faster toward a target than one with a lower angle pitch. Image size aircraft pitch command 816 is fed through limiter 818, which can cap or reduce image size aircraft pitch command 816 to avoid the interceptor aircraft attempting to execute a pitch that would cause it to become unstable. Limiter 818 generates limited aircraft pitch command 820. Pitch summer 824 sums limited aircraft pitch command 820 and autopilot pitch command 822 to obtain approach pitch command 826. Inner stability loop 450 can use approach pitch command 820 to pilot the interceptor aircraft in the direction of the tracked object. Autopilot pitch command 822 can be, for example, a portion of autopilot aircraft commands 445 corresponding to a single axis. In some embodiments, incorporating flight commands according to on-board camera 520 does not occur until a target is in range, which can be controlled, for example, by a switch that controls whether limited aircraft pitch command 816 reaches pitch summer 824. The switch can be controlled by central controller 115 or by a computer on-board the interceptor aircraft. In some embodiments, image size in camera 812 can be used to slow the velocity of an interception drone as it nears a target. In other embodiments, image size in camera 812 can be used to determine when a net gun mounted to the interceptor aircraft is fired at a target.

The above-described techniques can be implemented in digital electronic circuitry, or in computer hardware, firmware, software, or in combinations of them. The implementation can be as a computer program product, i.e., a computer program tangibly embodied in an information carrier, e.g., in a non-transitory machine-readable storage device, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps can be performed by one or more programmable processors executing a computer program to perform functions of the technology by operating on input data and generating output. Method steps can also be performed by, and apparatus can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer also includes, or be operatively coupled to receive data from or transfer data to, or both, one or more mass storage devices for storing data, e.g., magnetic, magneto-optical disks, or optical disks. Data transmission and instructions can also occur over a communications network. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the above described techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The above described techniques can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an example implementation, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact through a communication network. The relationship of client and server arises by virtue of computer programs running on the respective computers and having a client-server relationship to each other.

The technology has been described in terms of particular embodiments. The alternatives described herein are examples for illustration only and not to limit the alternatives in any way. The steps of the technology can be performed in a different order and still achieve desirable results. Other embodiments are within the scope of the following claims.

What is claimed is:

1. A method for drone interdiction, the method comprising:
detecting, using one or more radars, a target aircraft within a surveillance zone;
generating first one or more interceptor aircraft commands to direct an interceptor aircraft to the target aircraft, based on data from the one or more radars;
commanding the interceptor aircraft according to the first one or more interceptor aircraft commands;
acquiring a target image using a camera mounted on the interceptor aircraft;
generating, in response to determining the target aircraft is in the target image, second one or more interceptor aircraft commands to direct the interceptor aircraft to the target aircraft, based on at least one of the target image, a fixed camera target image from one or more fixed cameras and the data from the one or more radars; and
commanding the interceptor aircraft according to the second one or more interceptor aircraft commands.

2. The method of claim 1, further comprising:
tracking the target aircraft based on the fixed camera target image, a fixed camera system model, and the data from the one or more radars.

3. The method of claim 1, further comprising:
determining that the target aircraft is a threat.

4. The method of claim 3, wherein determining that the target aircraft is a threat comprises analyzing the fixed camera target image.

5. The method of claim 1, further comprising:
commanding the interceptor aircraft to an interceptor aircraft base station in response to determining the target aircraft is not a threat.

6. The method of claim 1, further comprising:
immobilizing, by the interceptor aircraft, the target aircraft.

7. The method of claim 6, wherein immobilizing, by the interceptor aircraft, the target aircraft comprises the interceptor aircraft using a net assembly to immobilize the target aircraft.

8. The method of claim 6, wherein immobilizing, by the interceptor aircraft, the target aircraft comprises the interceptor aircraft using a net gun to immobilize the target aircraft.

9. A method for drone interdiction, the method comprising:
detecting, using one or more radars, a target aircraft within a surveillance zone;
generating first one or more interceptor aircraft commands to direct an interceptor aircraft to the target aircraft, based on data from the one or more radars;
commanding the interceptor aircraft according to the first one or more interceptor aircraft commands;
acquiring a target image using a camera mounted on the interceptor aircraft;
determining, in response to determining the target aircraft is in the target image, an interception location, based on at least one of the target image, a fixed camera target image from one or more fixed cameras and the data from the one or more radars;
generating second one or more interceptor aircraft commands to direct the interceptor aircraft to the target aircraft, based on the interception location; and
commanding the interceptor aircraft according to the second one or more interceptor aircraft commands.

10. The method of claim 9, wherein determining, in response to determining the target aircraft is in the target image, an interception location, based on at least one of the target image, a fixed camera target image from one or more fixed cameras and the data from the one or more radars further comprises:
generating a first track state, based on the target image;
generating a first track score, based on the first track state;
generating a second track state, based on one or more of the fixed camera target image from the one or more fixed cameras and the data from the one or more radars;
generating a second track score, based on the second track state;
selecting the first track state or the second track state by comparing the first track score and the second track score.

11. The method of claim 9, further comprising:
immobilizing, by the interceptor aircraft, the target aircraft.

12. The method of claim 11, wherein immobilizing, by the interceptor aircraft, the target aircraft comprises using a net assembly to immobilize the target aircraft.

13. The method of claim 11, wherein immobilizing, by the interceptor aircraft, the target aircraft comprises using a net gun to immobilize the target aircraft.

14. The method of claim 9, further comprising:
tracking the target aircraft based on the fixed camera target image, a fixed camera system model, and the data from the one or more radars.

15. The method of claim 9, further comprising:
determining that the target aircraft is a threat.

16. The method of claim 15, wherein determining that the target is a threat comprises analyzing the fixed camera target image.

17. The method of claim 9, further comprising:
commanding the interceptor aircraft to an interceptor aircraft base station in response to determining the target aircraft is not a threat.

18. A method for drone interdiction, the method comprising:
detecting a target aircraft, based on data from one or more of: one or more radars, a fixed camera image from one or more fixed cameras, and an interceptor aircraft image from a camera mounted to an interceptor aircraft;
generating an interception location where the interceptor aircraft and the target aircraft are expected to meet;
directing, based on the interception location, the interceptor aircraft to the interception location to immobilize the target aircraft.

19. The method of claim 18, wherein directing, based on the interception location, the interceptor aircraft to the interception location to immobilize the target aircraft further comprises capturing the target aircraft using a hanging net.

20. The method of claim 18, wherein directing, based on the interception location, the interceptor aircraft to the interception location to immobilize the target aircraft further comprises firing a net gun at the target to capture the target aircraft.
